(19) United States
(12) Patent Application Publication
(10) Pub. No.: US 2007/0079714 A1
(43) Pub. Date: Apr. 12, 2007

(54) UPGRADE KIT FOR OFFSET PRINTERS

(76) Inventor: Richard G. Atwater, Rockford, IL (US)

Correspondence Address: VEDDER PRICE KAUFMAN & KAMMHOLZ, 222 N. LASALLE STREET, CHICAGO, IL, 60601, US

(21) Appl. No.: 11/163,203

(22) Filed: Oct. 10, 2005

(51) Int. Cl. B41F 31/02

(52) U.S. Cl. 101/350.1; 101/364; 101/350.6

(57) ABSTRACT

An upgrade kit for an offset printer that uses a slow speed roller for picking up controlled quantities of ink from an ink distribution rail and feeding the ink from the slow speed roller to a high speed roller. The kit includes a distribution head that has an orifice and a pair of transfer blades and an adjustment mechanism for pivoting the distribution head about a small center shaft to slightly vary the distance between one of the blades and the slow speed roller so that the ink from the ink pump may pass through the orifice and be smoothed by one of the blades before being distributed to the slow speed roller and for distribution to the high speed roller.

### BACKGROUND OF THE INVENTION

The present invention relates to a novel upgrade kit for existing offset printing presses. Typically, a medium sized printing press involves a pair of presses combined into one unit and feeding a web of material, usually paper, between the two presses. These may be thought of as mirror image halves of the same press wherein the web is printed on both sides because it is fed between a pair of substantially identical impression cylinders.

Because these are offset presses, a plate cylinder is a cylinder in peripheral contact with an impression cylinder. There are usually two (although there could be more) forming rollers which engage the plate cylinder, and these two forming rollers are in contact with a copper oscillating cylinder. In other words, this cylinder is oscillating or undergoes back and forth motion parallel to its rotational axis. There is a rubber transfer roller, typically made from a high durometer rubber, such as an 80 durometer rubber, and this transfer roller is in turn in contact with a copper oscillating roller which transfers an image to it.

These rollers, and one or more additional transfer rollers, are in peripheral contact with one another, and thereby travel at the same peripheral speed. Finally, there is a larger diameter, copper drum high speed inking roller. This copper drum oscillator, or high speed inking roller, usually receives its ink from an ink rail having a space between the surface of the high speed ink roller and the ink rail of usually about ten thousandths of an inch (0.010).

In this prior art construction, the ink rail is thus fed from the ink pump and the ink rail attempts to distribute the ink directly from the ink rail to the high speed roller.

Accordingly, this requires a certain comparatively large clearance of about 0.010, because the thickness of the ink film must be such as to thoroughly wet the surface of the high speed roller, without forming ink blots on the one hand or starving the roller surface on the other hand.

According to the invention, therefore, there is a need for an improved, simple apparatus and method for converting a press of the existing type into one having much better ink control than that previously available using the high speed inking roll which takes its ink directly from the stationary ink distribution rail.

Accordingly, the present invention involves a conversion kit which may be used with the existing high speed roller, but which uses a slow speed roller for picking up controlled quantities of ink from an ink distribution rail and feeding the ink in turn from this roller to the high speed roller. The conversion kit includes a novel distribution head, a drive motor, and a slow RPM roller, which are used to substitute for the existing ink rail which feeds ink directly to the high speed roller.

According to the preferred form of invention, a distribution head is provided which includes a pair of somewhat flexible wiper blades, one of which is active at any one time. For example, with counter-clockwise rotation, the upper wiper blade is 0.090 inches off the roller, while the lower wiper blade is about 0.003 to 0.006 inches off the roller. There is a clearance of about 0.020 inches between the slow speed roller and the orifice in the ink rail through which the ink flows. When the rotational direction is reversed and a clockwise rotation occurs, the upper wiper blade moves closer to the slow speed inking roller and the lower wiper blade is moved further away. The orifices and the chamber or reservoir just below or just above the orifices remains the same. There is a precision adjustment mechanism for insuring that the upper and lower flexible wiper blades may be positioned properly.

These preferably help smooth the ink film transferred to the slow speed roller. The ink film is then readily transferable to the high speed roller. The peripheral speed of the high speed roller is several times faster than the peripheral speed of the slow speed roller. There is a gap between the slow speed and the high speed rollers which affords a milling point for the ink and reduces it to about a 0.004 inch thickness as the ink engages and is transferred to the high speed roller.

According to the invention, the adjustment mechanism for the upper and lower wiper blades is independent of the swing arm motion which enables the roller to be spaced from the upper and lower wiper blades for cleaning, maintenance, etc. Thus, the present invention involves using an ink distribution head and using an added slow speed roller for use with a different inking system.

According to the invention, there is much less blotching of the ink and the unit is capable of producing a more precise and higher quality product, plus affording more careful control of the ink. Accordingly, it is an object of the invention to provide improved quality in an offset printing press.

Another object is to provide an improved ink distribution head assembly for use in an offset printing press.

A still further object is to provide an improved kit, which may be substituted in existing presses and which will require very little modification, and yet which provides greatly improved and simplified operation and results.

Another object is to provide an ink distribution head assembly which may be pivoted to a spaced-apart position for cleaning and maintenance, as well as for easy adjustment of the upper and lower wiper blades.

A still further object is to provide a slow speed roller with its own drive motor and control, whereby the peripheral speed of the slow speed roller may be varied independently of the speed of the high speed roller.

A further object of the invention is to provide a novel arrangement of upper and lower flexible blade assemblies with an ink reservoir for each blade, together with a distribution head ink orifice lying between the two, and an arrangement which also provides an easy adjustment means for the upper and lower blades.

A further object is to provide an apparatus which will operate satisfactorily with either hand of rotation and with minimum adjustment.

### SUMMARY OF THE INVENTION

These and other objects of the invention are achieved in practice by providing a roller conversion kit with the above purpose, which includes a slow speed roller, a driving motor and associated inking system, including upper and lower reservoirs and flexible wiper blades with a central ink feed unit, and which includes simple adjustments for clockwise or counterclockwise rotation.

The manner in which these objects and other objects of the invention are achieved in practice will become more clearly apparent when reference is made to the following detailed description of the preferred embodiment of the invention and shown in accompanying drawings, in which like reference numbers indicate corresponding parts throughout the several figures.

### BRIEF DESCRIPTION OF THE DRAWINGS

FIG. 1 is a vertical sectional view, partly diagrammatic in character, showing the slow speed roller, a high speed oscillating roller, upper and lower flexible wiper blades, ink reservoirs, an ink distribution head assembly and other components which enable the present invention to function;

FIG. 2 is an enlarged vertical sectional view of the slow speed roller and the ink distribution head, and showing the flexible wiper blades adjustable to different positions vis-a-vis the slow speed roller;

FIG. 2a is a fragmentary front elevational view of the drive motor for driving the slow speed roller at any predetermined speed;

FIG. 3 is a side elevational view of the swing frame of the invention, which carries the wiper blades and shows the mechanism for swinging the ink distribution head and related components away from the slow speed roller for maintenance and cleaning;

FIG. 4 is a diagrammatic vertical sectional view showing a pair of mirror image impression rollers with a web of printed material, such as paper, emerging from between the two rollers; and

FIG. 5 is a vertical sectional view showing the high speed ink rail and high speed roller accepting a rapid transfer of ink directly from the ink rail according to the prior art.

### DESCRIPTION OF THE PREFERRED EMBODIMENT OF THE INVENTION

While the present invention may be practiced in a number of different ways and certain modifications to the form of the apparatus shown will become apparent to those skilled in the art, a description of one preferred embodiment of the invention will now be given.

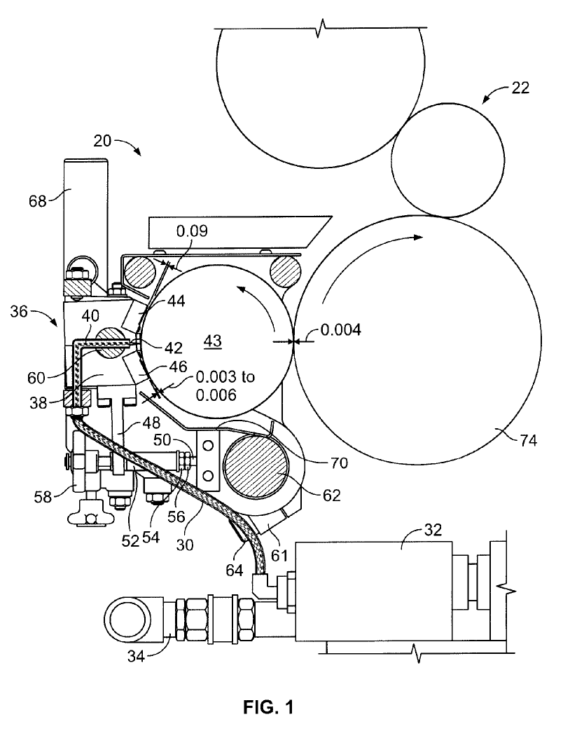

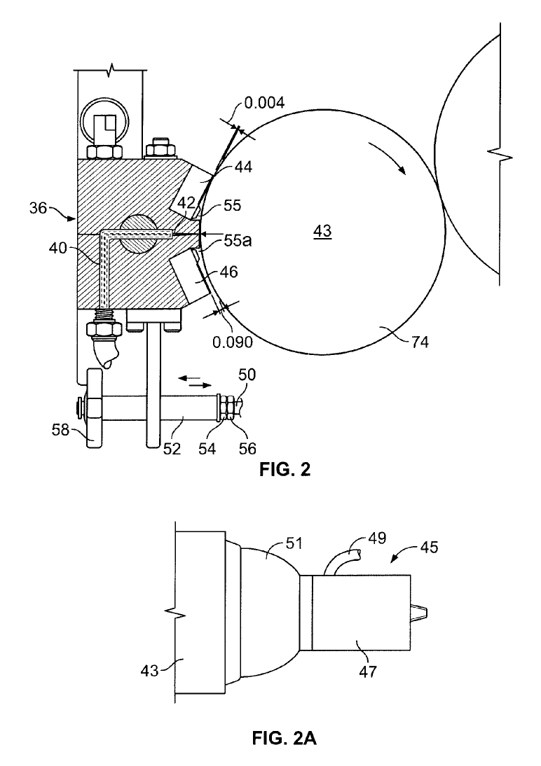

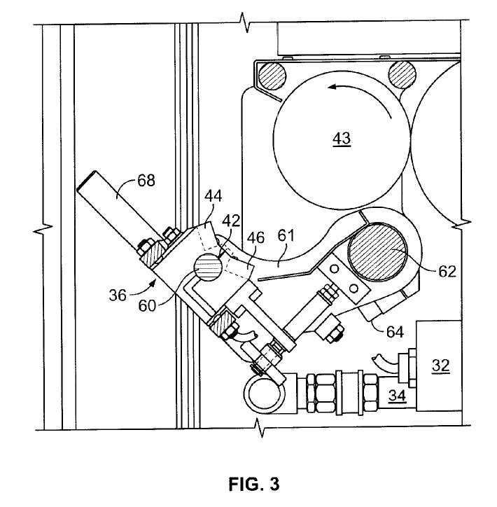

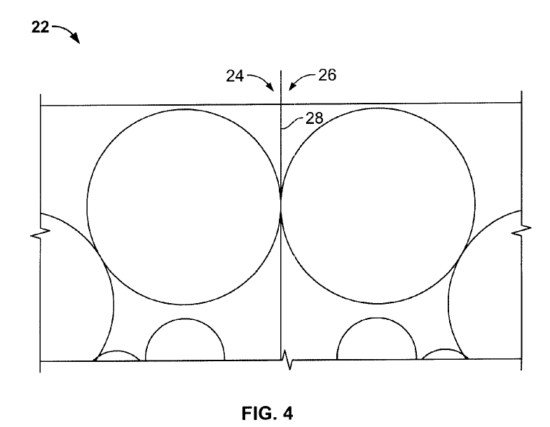

Referring now to the drawings in greater detail, there is shown a novel upgrade kit generally designated 20 and shown in FIG. 1 for use in an offset printing press generally designated 22 (FIGS. 1 and 4) and typically adapted to print both sides, generally designated 24, 26 (FIG. 4), of a web of paper or like material 28. The upgrade kit 20 (FIG. 1) includes a slow speed roller 43 and drive motor 45 (FIG. 2a), a flexible ink supply line 30 leading from an ink pump 32 which in turn is supplied by a larger volume master line 34. The drive motor 45 includes a housing 47, a power cable 49, and suitable gearing 51 for attachment to the slow speed roller 43. FIG. 1 also shows an adjustable ink distribution head assembly generally designated 36. Preferably, the slow speed roller 43 operates at a fixed rate of 15 RPM.

This distribution head assembly 36 includes a main body 38 and an enlarged size ink passage 40 leading to a reduced size orifice 42 from which the ink is spread out and ultimately supplied to the slow speed roller 43. The distribution head accommodates a charge of ink in the small contoured space or reservoirs 55, 55a between the orifice 42 and the blades 44, 46. Whatever ink accrues in this space 55 is then smoothed by the flexible blades, either 44 or 46, onto the roller 43. The ink is metered to the roller 43 by the ink pump 32, and needs only to be smoothed by the blades 44 or 46 as it is passed to the roller 43. The distribution head 36 includes an adjustable upper flexible transfer blade assembly 44 and an adjustable lower flexible transfer blade assembly 46; these blades 44, 46 are finely adjusted by pivoting the main body 38 about a small center shaft 60.

The distribution head assembly 36, for purposes of making fine adjustments to the transfer blades 44, 46 also includes an extension arm 48 positioned by a threaded shaft 50 extending into an elongated spacer 52 with lock nuts 54, 56 near one end thereof, and an adjustment handle 58 on its other end. This enables the blades 44, 46 to be moved and a precision adjustment of the clearance between the blades 44, 46 and the roller 43 to be made. These adjusting elements allow the distribution head to pivot slightly about the small center shaft 60, thus bringing the transfer blades 44, 46 slightly closer to or slightly farther from the roller 43.

The entire distribution head assembly 36 is mounted on a pivot frame 61, which can pivot about the enlarged support shaft 62. A locking bolt 64 pinches a lower portion of the pivot frame against the pivot shaft 62. An upper extension handle 68 is provided for ease in moving the pivot frame 61 about the pivot shaft.

Excessive ink is kept off the adjusting mechanism by a lower protective plate 70. A key part of the invention is the slow speed roller 43 onto which ink is fed from the small reservoir either 55 or 55a and blade 44 or 46 to slow speed roller 34 from the ink distribution head 38. This is initially the reservoir 55, which is fed by the ink pump 32 and smoothed out by the position of the transfer blade 44 or 46. This space may be about 0.020 inches, but the thickness of the ink film is smoothed by the transfer blade 46 to perhaps about 0.003 to about 0.020 inches. From the slow speed roller, the ink is taken up by the high speed roller 74. With a clearance of approximately 0.004 inches between these two drums or rollers, 43, 74, the ink is spread and smoothed much more evenly and there is far less trouble and fewer problems of criticality with adjustment than would be the case if the transfer were made between the distribution head 38 and the high speed roller 74.

Assuming now that one wishes to operate the inventive form of printing press of the invention, one would manipulate the motor 45 which would receive current through the cable 49 and through the gearing to operate the roller 43. Ink is then metered from the ink pump supply 32 through the passage 40 and it then passes through the reduced diameter orifice 42 and ultimately to the reservoirs 55 or 55a. After this, the blades 44, 46 smooth the ink just as it is being transferred to the roller 43.

Assuming that the slow speed roller 43 is rotating clockwise as shown in FIG. 2, the body 48 is adjusted by means of the handle and remainder of the mechanism 54, 56, 50 to the point where the upper transfer blade 44 has a clearance of, for example, 0.004 inches. The distribution head 36 is adjusted in this way, and when the desired clearance between the transfer blade 44 and the roller 43 is achieved, the adjustment remains in effect.

Assuming now that it would be desired to run the drum or roller 43 in the reverse or counter-clockwise direction, the motor 45 and its gear drive undergo a reversal in direction, and this moves the roller 43 in a counter-clockwise direction. The adjustment handle 58 is then moved so that the distribution head pivots about the shaft 60 and the lower transfer blade 46 assumes a space or clearance of from about 0.003 to about 0.006 inches from its previous spacing of about 0.090 inches. The upper transfer blade then is inherently adjusted to about 0.090 inches while the lower wiper blade 46 moves to a clearance of approximately 0.004.

This is all done simply with the adjustment handle moving the distribution head about the pivot point 60 without changing its distance of about 0.020 inches from the roller 43. In both cases, the slow speed roller 43 retains its own characteristic speed, preferably a speed of 15 RPM. The clearance of about 0.004 inches from the high speed roller enables the additional ink to be smoothed onto roller 43.

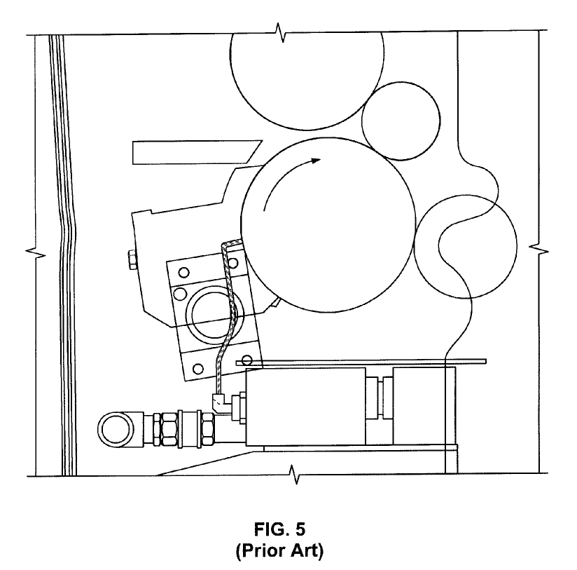

The entire apparatus, including that which is mounted on the swing frame 61 is made available to add onto an existing printing press. As will be noted from FIG. 5, the addition of the slow speed roller, the drive mechanism for it and the ink rail and swing frame are the only new parts which must be added to the existing apparatus.

When it comes time to perform maintenance on the apparatus, the locking bolt 64 is loosened and the swing frame 61 is lowered about the pivot shaft 62. This handle 68 is usually employed for this purpose. The distribution head 36 is thus pivoted away with the slow speed roller 34 and the transfer blades, without affecting the rest of the apparatus. In this way, the ink can be changed or other maintenance and cleaning performed. The apparatus can then be placed back in service by the simple expedient of pivoting the roller 43 and other parts about the shaft 62 in locking the ink rail 36 and the roller 43 in that position.

It will thus be seen that the present invention provides a new and improved upgrade for an offset printing press and a greatly improved method of applying ink in offset printers.

What is claimed is:

1. An upgrade kit for an offset printer, said kit comprising, in combination, an ink distribution head assembly including an ink distribution head, a slow speed roller, and a drive mechanism for said roller, said slow speed roller running at a peripheral speed no more than half the peripheral speed of an associated high speed roller, said ink distribution head being mounted for slight pivoting movement about a small center shaft, an ink supply line and an ink pump for supplying a controlled amount of ink to said ink distribution head, said distribution head including an orifice and a pair of transfer blades, one on each side of said orifice, an adjustment mechanism for pivoting said distribution head about said small center shaft to slightly vary the distance between one of said blades and said slow speed roller, whereby the ink from said ink pump may be spread out through said orifice, and smoothed by one of said blades before being distributed to said slow speed roller, and whereby said smoothed ink is supplied to said high speed roller from said low speed roller.

2. An upgrade kit for offset printers as defined in claim 1 wherein said ink distribution head includes a pair of small reservoirs, each reservoir lying between said orifice and one of said transfer blades.

3. An upgrade kit for offset printers as defined in claim 1 which further includes means for adjusting the space between said slow speed roller and said high speed roller.

4. An upgrade kit for an offset printer as defined in claim 1 wherein said distribution head assembly is mounted on a pivot frame, whereby said distribution head may be pivoted between and operative position wherein said slow speed roller is closely spaced from said high speed roller, and another position for maintenance or repair of said distribution head.

5. An upgrade kit as defined in claim 1 which includes a drive motor for said slow speed roller.

6. An upgrade kit as defined in claim 5 wherein said drive motor drives said slow speed roller about 15 rpm.

7. An upgrade kit as defined in claim 1, said slight pivoting movement of said ink distribution head being accomplished by an adjustment handle, whereby adjusting said handle pivots said distribution head about said center shaft.

8. An upgrade kit as defined in claim 1, said slight pivoting movement of said ink distribution head being accomplished by an extension arm, a spacer, at least one lock nut and an adjustment handle, whereby adjusting said handle pivots said distribution head about said center shaft.

9. An upgrade kit as defined in claim 4 which further includes a pivot shaft and a locking fastener, whereby said distribution head may be retained in any chosen position relative to said high speed roller.

10. An upgrade kit for an offset printer, said kit comprising, in combination, an ink distribution head assembly including an ink distribution head, a slow speed roller, and a drive mechanism for said roller, said slow speed roller running at about 15 rpm, said ink distribution head being mounted for slight pivoting movement about a small center shaft, an ink supply line and an ink pump for supplying a controlled amount of ink to said ink distribution head, said distribution head including a reduced diameter orifice and a pair of flexible transfer blades, one on each side of said orifice, small ink reservoirs between said orifice and said transfer blades, an adjustment mechanism including a handle and a threaded shaft, for pivoting said distribution head about said small center shaft to slightly vary the distance between one of said blades and said slow speed roller, whereby the ink from said ink pump may be spread out through said orifice, and smoothed by one of said blades before being distributed to said slow speed roller, and whereby said smoothed ink is supplied to said high speed roller from said low speed roller.
